(19) United States
(12) Patent Application Publication
(10) Pub. No.: US 2021/0312483 A1
(43) Pub. Date: Oct. 7, 2021

(54) METHOD AND ELECTRONIC DEVICE FOR PREDICTING AT LEAST ONE MACROECONOMIC VARIABLE

(71) Applicant: Mohit Maheshwari, Mumbai (IN)

(72) Inventors: Mohit Maheshwari, Mumbai (IN); David Newsam, Attalens (IN)

(21) Appl. No.: 17/266,755

(22) PCT Filed: Aug. 7, 2019
(86) PCT No.: PCT/IN2019/050577

§ 371 Date: Feb. 8, 2021

(30) Foreign Application Priority Data
Aug. 9, 2018 (IN) 201821029974

(51) Int. Cl. G06Q 30/02; G06N 20/00

(52) U.S. Cl. CPC G06Q 30/0202; G06N 20/00

(57) ABSTRACT

Embodiments herein disclose method for predicting at least one macroeconomic variable in an electronic device (100). The method includes obtaining, by the electronic device (100), at least one feature vector for the at least one macroeconomic variable. Further, the method includes configuring, by the electronic device (100), a bias model for the at least one feature vector, wherein the bias model filters an uncertain value in the at least one feature vector. Further, the method includes updating, by the electronic device (100), the at least one feature vector based on a priority factor represented by the macroeconomic variable and the configured bias model. Further, the method includes generating, by the electronic device (100), a prediction file based on the at least one updated feature vector. Further, the method includes predicting, by the electronic device (100), the macroeconomic variable in the electronic device based on the generated prediction file.

The present disclosure relates to a machine learning system, and more specifically related to a method and electronic device for predicting at least one macroeconomic variable. The present application is based on, and claims priority from an International application PCT/IN2019/050577 filed on 7 Aug. 2019 and Indian Application Number 201821029974 filed on 9 Aug. 2018, the disclosure of which is hereby incorporated by reference herein.

### FIELD OF INVENTION

### Background

There is no procedure for estimating forecast in imperfect information system using machine learning. In the existing method, the existing method can be used to calculate optimal response strategies extended form game information in a non-perfect. The method includes steps of initialization strategy, all the information sets the value of virtual and virtual regret value; based on the current policy, and opponents a game, and records the game results, the information set in this game each of which is accessed to calculate the virtual value of the set of information according to game results, obtained according to the procedure of the virtual value of each set of information to calculate the value of virtual regret every action on each information collection, the value of the matching process execution regret on each set of information to be accessed, updated policy on the information set, returns to step, until no game performed.

In the existing system, the existing system can be used for cognitive information processing. A cognitive information processing system environment which includes a plurality of data sources, a cognitive inference and learning system coupled to receive a data from the plurality of data sources, the cognitive inference and learning system processing the data from the plurality of data sources to provide cognitively processed insights, the cognitive inference and learning system further comprising performing a learning operation to iteratively improve the cognitively processed insights over time and a destination, the destination receiving the cognitively processed insights.

In another system, the system includes a social networking system receives from a member an item for sharing on the social networking system. The system determines whether the item for sharing is a first sharing for the member or whether the member has not shared an item for a time period that transgresses a threshold. When the item for sharing is a first sharing or a sharing that transgresses the threshold, the system marks the item for a promotion in a feed of another member of the social networking system.

In another system, the system does not account for bias modelling with the propensity measurement angle. In the existing system causality modelling is not exploited to be combined with algorithms like regret minimization in context of machine learning. The existing system does not include in any ways the combination and details of counterfactual regret minimization techniques, new unique derivatives, approaches. In the existing system the combination of bias modelling and propensity estimation in combination with regret minimization is not exploited.

In another system, the system doesn't disclose feature vector formulation stage involves the business problem formulation in terms of a feature vector, different labels referring to the questions relating to classifiers are tagged and represented to the available training data set.

In another system, the system doesn't disclose bias modelling stage involves every variable in the feature vector may be subject to a certain known or unknown bias, identifies in the first instance the variables in the feature vector which may be biased and then models the bias, wherein the feature vector is then bias filtered i.e. bias is removed and the sentiment engine translates the text specific variables to range bound values i.e 0 to 1 so that they can be treated appropriately in the current and consecutive steps.

In another system, the system doesn't disclose inverse probability weighting stage involves applying corrections to the feature vector depending on the importance of the different factors represented by the variables including the underrepresented factors due to missing information or unfeasibility, wherein characterizing the different factors on the basis of their probability of occurrence or impact on the output which is inverse propensity estimation and the inverse of the estimated propensities is applied to the feature vector to appropriately inflate or attenuate the underrepresented or less impactful factors respectively.

In another system, the system doesn't disclose counterfactual regret minimization stage involves the key algorithm that requires the basic principle on which the key algorithm operates as below, wherein generate a base strategy for output computation from the feature vector. Calculate the regret in the strategy from the known output history. Apply correction to the strategy depending on the regret value. Aggregate the new strategy with the previous strategy. Calculate cumulative regret value. Go to calculate the regret in the strategy from the known output history and continue till regret is minimized to the required degree of tolerance. Apply the resulting strategy to compute the future values of output variables for maximizing return. In case that computational limitation is encountered in terms of nodes, use end game resolution techniques to ensure regret minimized strategy can be computed by attenuating non influential data in the game abstraction.

Thus, it is desired to address the abovementioned disadvantages or other shortcomings or at least provide a useful alternative.

### OBJECT OF INVENTION

The principal object of the embodiments herein is to provide a method and electronic device for predicting at least one macroeconomic variable.

Another object of the embodiments herein is to obtain at least one feature vector for the at least one macroeconomic variable;

Another object of the embodiments herein is to configure a bias model for the at least one feature vector, wherein the bias model filters a uncertain value in the at least one feature vector.

Another object of the embodiments herein is to update the at least one feature vector based on a priority factor represented by the macroeconomic variable and the configured bias model.

Another object of the embodiments herein is to generate a prediction file based on the at least one updated feature vector.

Another object of the embodiments herein is to predict the macroeconomic variable in the electronic device based on the generated prediction file.

### SUMMARY

Accordingly the embodiments herein provide a method for predicting at least one macroeconomic variable in an electronic device. The method includes obtaining, by an electronic device, at least one feature vector for the at least one macroeconomic variable. Further, the method includes configuring, by the electronic device, a bias model for the at least one feature vector, wherein the bias model filters a uncertain value in the at least one feature vector. Further, the method includes updating, by the electronic device, the at least one feature vector based on a priority factor represented by the macroeconomic variable and the configured bias model. Further, the method includes generating, by the electronic device, a prediction file based on the at least one updated feature vector. Further, the method includes predicting, by the electronic device, the macroeconomic variable in the electronic device based on the generated prediction file.

In an embodiment, obtaining, by the electronic device, the feature vector for the macroeconomic variable includes determining a subset of variables for the macroeconomic variable, training the subset of variables using a predefined sample, and obtaining the feature vector based on the trained subset of variables.

In an embodiment, generating, by the electronic device, the prediction file based on the at least one updated feature vector comprises determining a subset of variables for a vector autoregressive regressions (VAR) model, determining a set of time-varying training and holdout sample windows for each subset of variables, generating the VAR model on a training sample, predicting a performance of the VAR model on a varying time-window, computing a prediction for a timeframe predictions across models as the VAR prediction for subset of variables, determining that the subset of variables are completed, selecting an optimal performing model using an mean absolute percentage error (MAPE) in a holdout timeframe, generating ensemble based prediction weighting value by inverse of MAPE values for the optimal performing model, and generating the prediction file based on the generated ensemble based prediction weighting value.

In an embodiment, generating, by the electronic device, the prediction file based on the at least one updated feature vector includes generating a training-validation and holdout sample in time series for machine learning (ML) procedure, training a Gradient Boosting based prediction model and/or counterfactual regret minimization based prediction model on at least one of a training sample and a cross-validation sample, predicting a variable of interest in a training-validation and holdout sample, generating ensemble based prediction weighting value by inverse of MAPE values for each Gradient Boosting based prediction model and/or counterfactual regret minimization based prediction model, and generating the prediction file based on the generated ensemble based prediction weighting value.

The macroeconomic variable is currency exchange information, commodities data, service provider information, crude price, a commodity supply variable, a supply chain, a procurement value, and sales information.

Accordingly the embodiments herein provide an electronic device for predicting at least one macroeconomic variable. The electronic device includes a processor coupled with a memory. The processor is configured to obtain at least one feature vector for the at least one macroeconomic variable. Further, the processor is configured to configure a bias model for the at least one feature vector. The bias model filters a uncertain value in the at least one feature vector. Further, the processor is configured to update the at least one feature vector based on a priority factor represented by the macroeconomic variable and the configured bias model. Further, the processor is configured to generate a prediction file based on the at least one updated feature vector. Further, the processor is configured to predict the macroeconomic variable in the electronic device based on the generated prediction file.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1A is a block diagram of an electronic device for predicting at least one macroeconomic variable, according to embodiments as disclosed herein;

FIG. 1B illustrates various elements in a processor, according to embodiments as disclosed herein;

FIG. 2 is a flow chart illustrating a method for predicting the at least one macroeconomic variable in the electronic device, according to embodiments as disclosed herein;

FIG. 3 is an example flow chart illustrating a method for predicting the at least one macroeconomic variable in the electronic device, according to embodiments as disclosed herein; and

FIG. 4 is an example illustration in which system includes a hosted platform and private platform connected over a secure communication channel in a hybrid cloud environment, according to embodiments as disclosed herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

Accordingly the embodiments herein disclose a method for predicting at least one macroeconomic variable in an electronic device. The method includes obtaining, by an electronic device, at least one feature vector for the at least one macroeconomic variable. Further, the method includes configuring, by the electronic device, a bias model for the at least one feature vector, wherein the bias model filters a uncertain value in the at least one feature vector. Further, the method includes updating, by the electronic device, the at least one feature vector based on a priority factor represented by the macroeconomic variable and the configured bias model. Further, the method includes generating, by the electronic device, a prediction file based on the at least one updated feature vector. Further, the method includes predicting, by the electronic device, the macroeconomic variable in the electronic device based on the generated prediction file.

The method can be used to estimate the forecast of at least one macroeconomic variable in the electronic device (e.g., imperfect information system) using a combination of techniques like counterfactual regret minimization, inverse propensity estimation and debiased collaborative filtering in feature vectors.

The proposed method can be implemented in all business functions (e.g., sales sector, production sector, procurement across industries FMCG, manufacturing sector, pharmaceuticals sector or the like).

The present method relates to a counterfactual regret minimization in the electronic device by exploiting a unique combination of causal modelling, bias modelling, inverse propensity estimation, sentiment analysis in machine learning environment to finally predict the business variable (e.g. price, volume) in a time series procedure with higher accuracy with established higher confidence.

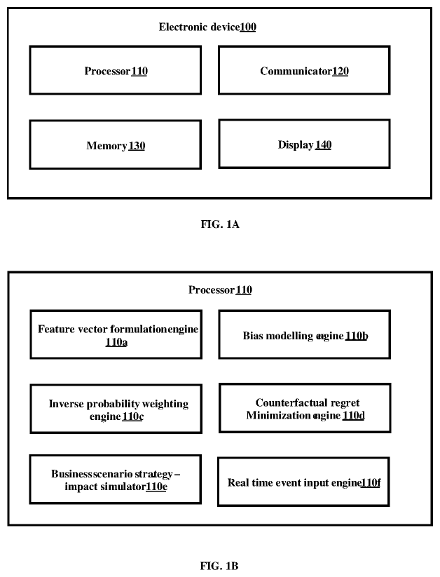

Referring now to the drawings, and more particularly to FIGS. 1A through 4, where similar reference characters denote corresponding features consistently throughout the figures, there are shown preferred embodiments.

FIG. 1A is a block diagram of an electronic device (100) for predicting at least one macroeconomic variable, according to embodiments as disclosed herein. The electronic device (100) can be, for example, but not limited to a smart phone, a Personal Digital Assistant (PDA), a tablet computer, a laptop computer, a smart watch, an imperfect information system or the like.

In an embodiment, the electronic device (100) includes a processor (110), a communicator (120), a memory (130), and a display (140). The processor (110) is coupled with the communicator (120), the memory (130), and the display (140).

In an embodiment, the processor (100) is configured to obtain at least one feature vector for the at least one macroeconomic variable. In an embodiment, the processor (110) is configured to determine a subset of variables for the macroeconomic variable and train the subset of variables using the predefined sample. Based on the trained subset of variables, the processor (110) is configured to obtain the feature vector.

In an example, for the feature vector, all the values are prices of corn, crude, soyabean and so on. Sentiment values are obtained from sentiment analysis. output vector y=[corn] and input vector x=[corn crude soyabean hedge_price sentiment].

Further, the processor (110) is configured to configure a bias model for the at least one feature vector. The bias model filters an uncertain value in the at least one feature vector. Example of priority factor which compensates for the uncertainty in the input variables: k=[1 1.2 0.9 1 1]. Then, the input vector is multiplied by the k vector to adjust for the uncertainties and bias in different input variables.

Further, the processor (110) is configured to update the at least one feature vector based on the priority factor represented by the macroeconomic variable and the configured bias model. Further, the processor (110) is configured to generate a prediction file based on the at least one updated feature vector.

Further, the processor (110) is configured to predict the macroeconomic variable in the electronic device (100) based on the generated prediction file.

In an embodiment, the processor (110) is configured to determine a subset of variables for a VAR model. Further the processor (110) is configured to determine the set of time-varying training and holdout sample windows for each subset of variables. Further the processor (110) is configured to generate the VAR model on a training sample. Further the processor (110) is configured to predict a performance of the VAR model on a varying time-window. Further the processor (110) is configured to compute a prediction for timeframe predictions across models as the VAR prediction for subset of variables. Further the processor (110) is configured to determine that the subset of variables are completed.

In an example, training timeframe could be from 1990-2018 i.e. t=28 years and Subset of variables could be x1′=[corn crude sentiment], x2′=[corn soyabean hedge_price sentiment] or x3′=[corn crude hedge_price sentiment] etc. The vector auto regression means output as a linear combination of input vectors. An example could be: yn=a*yn−1+b*x1(n−1)′+c*x1(n−2)′+d*x2(n−1)′+b*x3(n−1)′.

Further the processor (110) is configured to select an optimal performing model using a MAPE in a holdout timeframe. The holdout timeframe is a time period for which the output variable is predicted using input variables. For e.g. Holdout timeframe could be 2 yrs, 3 yrs, 24 yrs etc. Further the processor (110) is configured to generate ensemble based prediction weighting value by inverse of MAPE values for the optimal performing model. Further the processor (110) is configured to generate the prediction file based on the generated ensemble based prediction weighting value.

In another embodiment, the processor (110) is configured to generate a training-validation and holdout sample in time series for ML procedure. Further the processor (110) is configured to train a Gradient Boosting based prediction model and/or counterfactual regret minimization based prediction model on at least one of a training sample and a cross-validation sample. Further the processor (110) is configured to predict a variable of interest in a training-validation and holdout sample. Further the processor (110) is configured to generate ensemble based prediction weighting value by inverse of MAPE values for each Gradient Boosting based prediction model and/or counterfactual regret minimization based prediction model. Further the processor (110) is configured to generate the prediction file based on the generated ensemble based prediction weighting value.

In an example, manually variable subsets are chosen and the VAR method is used to train the models to predict output variable. In another example, the ML procedure itself chooses the subsets of variables and uses gradient boosting method and/or counterfactual regret minimization for curve fitting between input and output variables. The gradient boosting based prediction model and/or counterfactual regret minimization based prediction model is a standard established method for model training. All the above models are used to predict output variable in the holdout timeframe. The error/uncertainty is computed since the output variable values are known in the holdout timeframe. The error/uncertainty=[y(known)−y (predicted)]/y(known).

The MAPE is the average of all the error/uncertainty values in a given holdout timeframe. Uncertainty values could be 2%, 5%, 1% etc.

The most accurately predicting models are selected from the manual and ML algorithm trained models. The MAPE values for all these models are calculated. The prediction of the output variable for the future is calculated using these chosen models. Their predicted values are averaged using weighted average. For e.g. say 6 most accurate models are selected. Let their MAPE values be e1, e2, e3, e4, e5, and e6 respectively. The final output variable value is calculated as: y(final)=[(1/e1)*y1+(1/e2)*y2+(1/e3)*y3+(1/e4)*y4+(1/e5)*y5+(1/e6)*y6]/[1/e1+1/e2+1/e3+1/e4+1/e5+1/e6].

Further, the communicator (120) is configured for communicating internally between internal hardware components and with external devices via one or more networks. The memory (130) stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory” may indicate that the storage medium is not embodied in a carrier wave or a propagated signal. However, the term “non-transitory” should not be interpreted that the memory (130) is non-movable. In some examples, the memory (130) can be configured to store larger amounts of information than the memory. In certain examples, a non-transitory storage medium may store data that can, over time, change (e.g., in Random Access Memory (RAM) or cache). The display (140) displays the at least one predicted macroeconomic variable in the electronic device (100).

Although the FIG. 1A shows various hardware components of the electronic device (100) but it is to be understood that other embodiments are not limited thereon. In other embodiments, the electronic device (100) may include less or more number of components. Further, the labels or names of the components are used only for illustrative purpose and does not limit the scope of the invention. One or more components can be combined together to perform same or substantially similar function to predict the at least one macroeconomic variable.

FIG. 1B illustrates various elements in the processor (110), according to embodiments as disclosed herein. In an embodiment, the processor (110) includes a feature vector formulation engine (110a), a bias modelling engine (110b), an inverse probability weighting engine (110c), a counterfactual regret minimization engine (110d), a business scenario-strategy-impact simulator (110e) and a real time event input engine (110f).

In an embodiment, the feature vector formulation engine (110a) formulates the business problem in terms of the feature vector. Different labels referring to questions relating to classifiers are tagged and represented to the available training data set. The bias modelling engine (110b) is provided such that every variable in the feature vector may be subject to a certain known or unknown bias. The bias modelling engine (110b) identifies in a first instance the variables in the feature vector which may be biased and then models the bias. The feature vector in then bias filtered i.e., bias is removed. The sentiment engine (not shown) translates the text specific variables to range bound values i.e., 0-1 so that the variables can be treated appropriately in the current and consecutive steps. The inverse probability weighting engine (110c) applies corrections to the feature vector depending on the importance of the different factors represented by the variables including the underrepresented factors due to missing information or unfeasibility. The first process is characterizing the different factors on the basis of their probability of occurrence or impact on the output which is inverse propensity estimation. The inverse of the estimated propensities is applied to the feature vector to appropriately inflate or attenuate the underrepresented or less impactful factors respectively. The counterfactual regret minimization engine (110d) generates a base strategy for output computation from the feature vector. Further, the counterfactual regret minimization engine (110d) computes the regret in the strategy from the known output history. Further, the counterfactual regret minimization engine (110d) applies correction to the strategy depending on the regret value. Further, the counterfactual regret minimization engine (110d) aggregates the new strategy with the previous strategy. Further, the counterfactual regret minimization engine (110d) calculates cumulative regret value. Further, the counterfactual regret minimization engine (110d) calculates the regret in the strategy from the known output history and continues till regret is minimized to the required degree of tolerance. Further, the counterfactual regret minimization engine (110d) applies the resulting strategy to compute the future values of output variables for maximizing return. In case, the computations become too numerous to be executed by the computational resources such as primary memory and processor power, the end game resolution procedures are used to attenuate the less significant factors/variables in the input vectors and updated input vectors with reduced number of variables are used in the model training.

The real time event input engine (110f) is fed by real time public data feeds e.g. government agencies provided data relating to employment, currency exchange, commodities data, etc. and real time licensed data feeds such as news feeds from service providers like reuters. The real time event input engine (110f) itself transforms, filters, cleanses, repairs and rejects the various data inputs and makes it ready to supplied to the feature vector module in case of the hosted platform. The engine architecture is similar in functioning for private platform, nevertheless the real time application data input is client or business application specific e.g. data arriving from the machines on shop floor for manufacturing setup, real time sale data for a business operation. Real time private data refers to data internal to the client or business or organization which is utilizing this private platform e.g. tests data from the research and development (R&D)centers.

Although the FIG. 1B shows various hardware components of the processor (110) but it is to be understood that other embodiments are not limited thereon. In other embodiments, the processor (110) may include less or more number of components. Further, the labels or names of the components are used only for illustrative purpose and does not limit the scope of the invention. One or more components can be combined together to perform same or substantially similar function to predict the at least one macroeconomic variable.

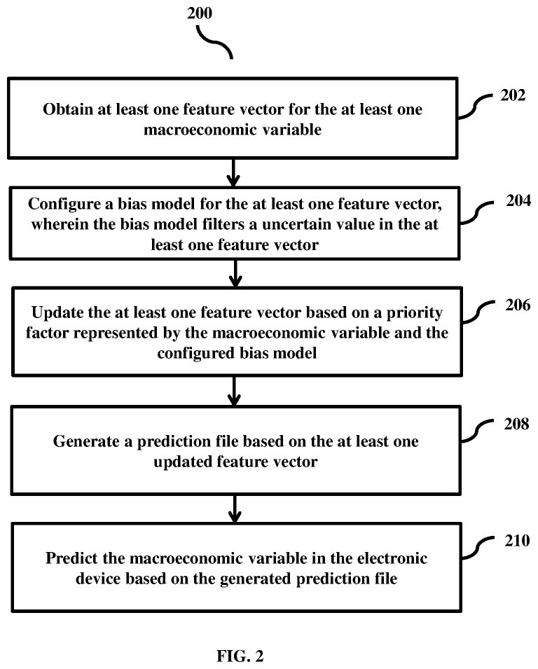

FIG. 2 is a flow chart (200) illustrating a method for predicting the at least one macroeconomic variable in the electronic device (100), according to embodiments as disclosed herein. The operations (202-210) are performed by the processor (110).

At 202, the method includes obtaining the at least one feature vector for the at least one macroeconomic variable. At 204, the method includes configuring the bias model for the at least one feature vector. The bias model filters the uncertain value in the at least one feature vector. At 206, the method includes updating the at least one feature vector based on the priority factor represented by the macroeconomic variable and the configured bias model. At 208, the method includes generating the prediction file based on the at least one updated feature vector. At 210, the method includes predicting the macroeconomic variable in the electronic device (100) based on the generated prediction file.

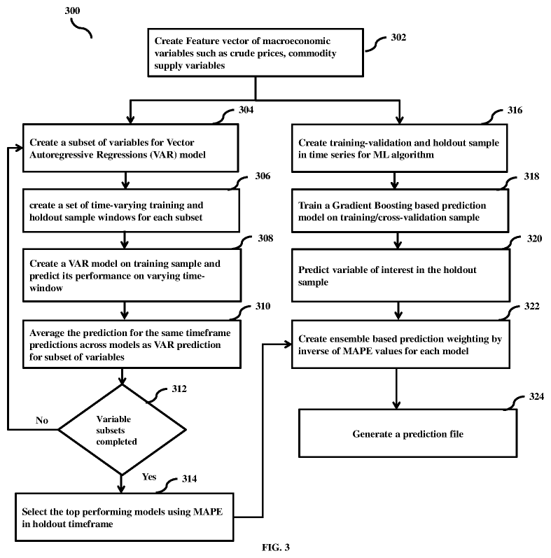

FIG. 3 is an example flow chart (300) illustrating a method for predicting the at least one macroeconomic variable in the electronic device (100), according to embodiments as disclosed herein. The operations (302-324) are performed by the processor (110).

At 302, the method includes creating the feature vector of the macroeconomic variables. At 304, the method includes creating the subset of variables for the VAR model. At 306, the method includes creating the set of time-varying training and holdout sample windows for each subset. At 308, the method includes creating the VAR model on the training sample and predicting its performance on the varying time-window. At 310, the method includes averaging the prediction for the same timeframe predictions across models as VAR prediction for subset of variables. At 312, the method includes determining whether the variable subsets are completed. If the variable subsets are not completed then, the method performs the operation of 304.

If the variable subsets are completed then, at 314, the method includes selecting the top performing models using the MAPE in the holdout timeframe. At 316, the method includes creating the training-validation and holdout sample in time series for ML procedure. At 318, the method includes training the gradient boosting based prediction model and/or counterfactual regret minimization based prediction model on training/cross-validation sample. At 320, the method includes predicting the variable of interest in the holdout sample. At 322, the method includes creating ensemble based prediction weighting by inverse of MAPE values for each model. At 324, the method includes generating the prediction file.

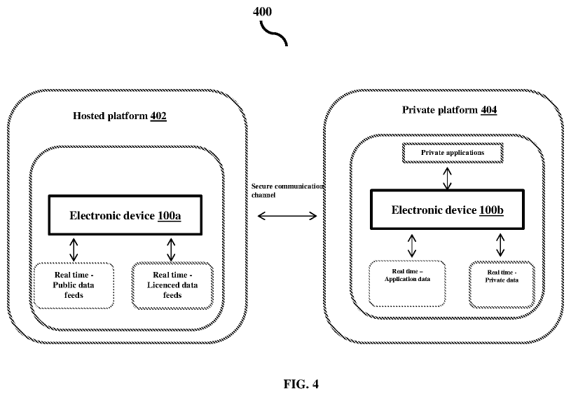

FIG. 4 is an example illustration in which system (400) includes a hosted platform and private platform connected over a secure communication channel in a hybrid cloud environment, according to embodiments as disclosed herein. The operations and functions of the electronic device (100a and 100b) are already explained in conjunction with the FIG. 1 and FIG. 2. As shown in the FIG. 4, the hybrid cloud infrastructure (400) includes a hosted platform (402) as well as a private platform (404). The hosted platform (402) includes the electronic device (100a) and the private platform (404) includes the electronic device (100b).

The electronic device (100a) itself transforms, filters, cleanses, repairs and rejects the various data inputs and makes it ready to supplied to the feature vector module in case of hosted platform. The architecture of the electronic device (100a) is similar in functioning for private platform, nevertheless the real time application data input is client or business application specific e.g. data arriving from the machines on shop floor for manufacturing setup, real time sale data for a business operation. Real time private data refers to data internal to the client or business or organization which is utilizing this private platform e.g. tests data from the research and development (R&D) centers. The system allows the business users to setup a scenario which is a combination of selection of the variables of the feature vector and set them as constants or variables with the respective values. Once this is checked and balanced, the counterfactual regret minimization module generates the strategies based on the business scenario setting to derive the business variable results.

In an embodiment in FIG. 4, the general output of the simulator with features of the variable setting, constant setting and the impact calculation form the proposed method. In case cyclicity or indefinite looping, the counterchecks are introduced at the scenario setting level for the simulator. Likewise the hosted and private cloud infrastructure platform may also include a cloud management application to ensure the access rights and error logging function related to the application performance. In various embodiments, a secure tunnel such as a virtual private network (VPN) tunnel is implemented to allow the hosted platform and the on-site private platform to communicate with one another. In these embodiments, the ability to communicate with one another allows the hosted platform and the private platform to work collaboratively when generating insights described in greater detail herein. The private applications can potentially provide inputs or receive the results from parts of the application modules and utilize them in the private environment as per need. The hosted platform is the encapsulation of the data input modules, the various applications on the principal basis that it can be connected via secure communication channel. Likewise private platform is also the encapsulation of the data input modules, the various applications, private applications on the principal basis that it can be connected via secure communication channel Passovers sequence of input or output pass over between the application modules is below. Feature vector formulation in the business scenario. Real time event input engine collects the relevant training data set real time and making it ready for processing. Further, the business scenario strategy impact simulator (110e) represents the business scenario strategy impact. When the business user starts to interact with the business scenario strategy impact simulator (110e) to calculate the impact, the sequence of passovers is as below. The business scenario strategy impact simulator (110e) sets up the business conditions. The feature vector formulation engine (110a) fixes the variable and constants.

The major advantage of the proposed method over existing method is the higher accuracy of the predictions or forecasts in the electronic device. The method can be used to drive better business forecasts (with more accuracy) in business functions like procurement, sales, supply chain to maximize returns. The extent of commercial benefit when the error in time series forecast is improved by fractions or even 1 to 2% amounts to an order of USD100000 savings in settings of organizations with substantial exposure to raw materials costs. Forecasting of commodity prices and volumes to a better degree of accuracy. The present disclosure enables more accurate time series forecast in the electronic device (100).

The various actions, acts, blocks, steps, or the like in the flow charts (200 and 300) may be performed in the order presented, in a different order or simultaneously. Further, in some embodiments, some of the actions, acts, blocks, steps, or the like may be omitted, added, modified, skipped, or the like without departing from the scope of the invention.

The embodiments disclosed herein can be implemented through at least one software program running on at least one hardware device and performing network management functions to control the elements.

The foregoing description of the specific embodiments will so fully reveal the general nature of the embodiments herein that others can, by applying current knowledge, readily modify and, or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A method for predicting at least one macroeconomic variable in an electronic device (100), comprising:
obtaining, by an electronic device (100), at least one feature vector for the at least one macroeconomic variable;
configuring, by the electronic device (100), a bias model for the at least one feature vector, wherein the bias model filters an uncertain value in the at least one feature vector;
updating, by the electronic device (100), the at least one feature vector based on a priority factor represented by the macroeconomic variable and the configured bias model;
generating, by the electronic device (100), a prediction file based on the at least one updated feature vector; and
predicting, by the electronic device (100), the macroeconomic variable in the electronic device (100) based on the generated prediction file.

2. The method of claim 1, wherein obtaining, by the electronic device (100), the feature vector for the macroeconomic variable comprises:
determining a subset of variables for the macroeconomic variable;
training the subset of variables using a predefined sample; and
obtaining the feature vector based on the trained subset of variables.

3. The method of claim 1, wherein generating, by the electronic device (100), the prediction file based on the at least one updated feature vector comprises:
determining a subset of variables for a vector autoregressive regressions (VAR) model;
determining a set of time-varying training and holdout sample windows for each subset of variables;
generating the VAR model on a training sample;
predicting a performance of the VAR model on a varying time-window;
computing a prediction for a timeframe predictions across models as the VAR prediction for subset of variables;
determining that the subset of variables are completed;
selecting an optimal performing model using an mean absolute percentage error (MAPE) in a holdout timeframe;
generating ensemble based prediction weighting value by inverse of MAPE values for the optimal performing model; and
generating the prediction file based on the generated ensemble based prediction weighting value.

4. The method of claim 1, wherein generating, by the electronic device (100), the prediction file based on the at least one updated feature vector comprises:
generating a training-validation and holdout sample in time series for machine learning (ML)procedure;
training at least one of a Gradient Boosting based prediction model and a counterfactual regret minimization based prediction model on at least one of a training sample and a cross-validation sample;
predicting a variable of interest in a training-validation and holdout sample;
generating ensemble based prediction weighting value by inverse of MAPE values for at least one of the Gradient Boosting based prediction model and the counterfactual regret minimization based prediction model; and
generating the prediction file based on the generated ensemble based prediction weighting value.

5. The method of claim 1, wherein the macroeconomic variable is currency exchange information, commodities data, service provider information, crude price, a commodity supply variable, a supply chain, a procurement value, and sales information.

6. An electronic device (100) for predicting at least one macroeconomic variable, comprising:
a memory (130); and
a processor (110), coupled with the memory (120), configured to:
obtain at least one feature vector for the at least one macroeconomic variable;
configure a bias model for the at least one feature vector, wherein the bias model filters a uncertain value in the at least one feature vector;
update the at least one feature vector based on a priority factor represented by the macroeconomic variable and the configured bias model;
generate a prediction file based on the at least one updated feature vector; and
predict the macroeconomic variable in the electronic device based on the generated prediction file.

7. The electronic device (100) of claim 6, wherein obtain the feature vector for the macroeconomic variable comprises:
determine a subset of variables for the macroeconomic variable;
train the subset of variables using a predefined sample;
obtain the feature vector based on the trained subset of variables.

8. The electronic device (100) of claim 6, wherein generate the prediction file based on the at least one updated feature vector comprises:
determine a subset of variables for a vector autoregressive regressions (VAR) model;
determine a set of time-varying training and holdout sample windows for each subset of variables;
generate the VAR model on a training sample;
predict a performance of the VAR model on a varying time-window;
compute a prediction for a timeframe predictions across models as the VAR prediction for subset of variables;
determine that the subset of variables are completed;
select an optimal performing model using a mean absolute percentage error (MAPE) in a holdout timeframe;
generate ensemble based prediction weighting value by inverse of MAPE values for the optimal performing model; and
generate the prediction file based on the generated ensemble based prediction weighting value.

9. The electronic device (100) of claim 6, wherein generate the prediction file based on the at least one updated feature vector comprises:
generate a training-validation and holdout sample in time series for machine learning (ML) procedure;
train at least one of a Gradient Boosting based prediction model and a counterfactual regret minimization based prediction model on at least one of a training sample and a cross-validation sample;
predict a variable of interest in a training-validation and holdout sample;
generate ensemble based prediction weighting value by inverse of MAPE values for at least one of the Gradient Boosting based prediction model and the counterfactual regret minimization based prediction model; and
generate the prediction file based on the generated ensemble based prediction weighting value.

10. The electronic device (100) of claim 6, wherein the macroeconomic variable is currency exchange information, commodities data, service provider information, crude price, a commodity supply variable, a supply chain, a procurement value, and sales information.
